(19) United States
(12) Patent Application Publication
(10) Pub. No.: US 2025/0209051 A1
(43) Pub. Date: Jun. 26, 2025

(54) Vector Database Based on Three-Dimensional Fusion

(71) Applicant: Guobiao ZHANG, Corvallis, OR (US)

(72) Inventor: Guobiao ZHANG, Corvallis, OR (US)

(73) Assignees: Southern University of Science and Technology, ShenZhen (CN); HangZhou HaiCun Information Technology Co., Ltd., HangZhou (CN)

(21) Appl. No.: 19/001,398

(22) Filed: Dec. 24, 2024

(30) Foreign Application Priority Data
Dec. 25, 2023 (CN) 202311815527.5
Jan. 16, 2024 (CN) 202410066648.2

(51) Int. Cl. G06F 16/22

(52) U.S. Cl. CPC G06F 16/2237; G06F 16/2246

(57) ABSTRACT

A vector database with 3-D fusion fuses processor into storage, i.e., it lowers the processing circuit (i.e., vector-distance calculating circuit, or VDCC) down to the lowest level of the storage circuit (i.e., storage arrays). Moreover, the VDCC and the storage arrays are 3-D integrated. By greatly reducing granularity and using massive parallelism, the present invention empowers accurate and fast brute-force search of the high-dimensional and large-scale vector database.

### FIELD OF THE INVENTION

The present invention relates to the field of databases, and more particularly to vector databases.

### PRIOR ART

A vector database is a database specifically designed to store and query high-dimensional vectors. It is commonly used in artificial intelligence (AI) applications. The proliferation of vector database is largely fueled by two trends: the first one is an explosive growth of unstructured data such as images, videos, audios, texts and others; the second one is the development of vector embeddings that can effectively transform unstructured data into feature vectors. Although it is originated from a conventional database, vector database, to work for AI, does much improvement on the conventional database and becomes an independent field.

For a conventional database (which stores scalar data types), searching is to find an exact match to a keyword. For a vector database (which stores vector data types), searching is similarity-based, which is to find vectors that are most similar to a query. Vector databases use a number of different algorithms that all participate in Approximate Nearest Neighbor (ANN) search and allow for large volumes of related information to be retrieved quickly and efficiently.

FIG. 1A illustrates a typical vector database 70. It stores a series of data vectors V₀, V₁, V₂ . . . Vᵢ . . . . Vectors are mathematical representations of data points in a multi-dimensional space, where each dimension corresponds to a specific feature or attribute. The dimension of data vectors in a vector database 70 ranges from tens to thousands. The input 76 of the vector database 70 includes a query vector V_{q}, while the output 77 includes a resultant vector Vᵣ, which is most similar to the query vector V_{q}.

FIG. 1B illustrates a querying process. This is a simplified vector space with two dimensions (2-D) d1 and d2. Each data vector Vᵢ is represented by a point in the vector space, and the query vector V_{q} is also represented by a point in the vector space. Their distance Dᵢ is the vector distance between the query vector V_{q} and the data vector Vᵢ. In theory, all data vectors Vᵢ in the vector database 70 need to be scanned, i.e., a vector distance Dᵢ is calculated between each data vector Vᵢ and the query vector V_{q}, then these vector distances are sorted. In the example of FIG. 1B, the data vector Vₘ has the minimum distance Dₘ from the query vector V_{q} and therefore, Vₘ is the nearest neighbor to V_{q}; the data vector Vₘ₋₁ has the second minimum distance Dₘ₋₁ from V_{q} and therefore, Vₘ₋₁ is the second nearest neighbor to V_{q}; and so on. Overall, the data vectors with k (k≥1) minimum distances (Vₘ, Vₘ₋₁ . . . ) are the k nearest neighbors to the query vector V_{q}, which are often referred to as top-k nearest neighbors (KNN). The above scanning process is referred to as brute-force search.

It is impractical to conduct brute-force search for a conventional hardware (more particularly for the von Neumann architecture). Although it is not difficult to satisfy the storage needs for a vector database, the prior-art storage is dumb, i.e., without any search capability. Because the processor is separated from storage in the conventional hardware and each processor needs to process data from at least a storage die, a brute-force search takes hours, too long to be acceptable.

To speed up search, prior art generally uses software approaches, more particularly indexing. Common indexing methods include quantization-based indexing, graph-based indexing and tree-based indexing. FIG. 1C illustrates a quantization-based indexing. It applies a quantizer Z to map vectors V₁-V₁₀ to three buckets 10 to 30 with centroids being c₁ to c₃, thus Z(V₁), Z(V₂), Z(V₃), Z(V₄)=c₁; Z(V₅), Z(V₆), Z(V₇)=c₂; and, Z(V₈), Z(V₉), Z(V₁₀)=c₃. During the querying process, the query vector V_{q} is first mapped to a bucket 20 by the quantizer Z, i.e., Z(V_{q})=c₂, then its nearest neighbor is searched within this bucket 20 and found to be V₇. By limiting searches to a single bucket, the quantization-based indexing can speed up the querying process.

Indexing suffers low accuracy. As shown in FIG. 1C, for the query vector V_{q}′, because it is quantized to the bucket 20, i.e., Z(V_{q}′)=c₂, its nearest neighbor is determined to be V₅. In fact, as V_{q}′ is closer to V₂ of the bucket 10, its nearest neighbor should be V₂. This type of error is unavoidable when the query vector is near a boundary of a bucket. It becomes even pronounced for high-dimensional vector (>1,000 dimensions). Another issue suffered by indexing is that it requires pre-computing, i.e., computing the index file of the whole vector database before querying. For a large-scale vector database (e.g., containing >10⁹ vectors), indexing is computing intensive and time consuming. Furthermore, indexing is not suitable for dynamic data or dynamic metrics. Once an index is computed, if there is any change in the vector data or the distance metrics (i.e., vector-distance calculating algorithms), the whole index needs to be re-computed. Finally, the index file needs to be loaded to the main memory during querying. This requires a large main memory and results in a high system cost.

Although it works well for conventional database (which stores scalar data types), indexing does not work well for the vector database (which stores vector data types). Indexing-based vector databases are typically limited to small-dimension (thousands) and small-scale (billions, 10⁹ vectors). This might be adequate for small knowledge bases, but far from enough for a general knowledge base which stores the whole human knowledge (i.e., world knowledge base). The world knowledge base contains trillions (10¹²) to quadrillion (10¹⁵) vectors. For the vector database of this scale, software approach is not enough, and new hardware needs to be developed.

### OBJECT OF THE INVENTION

It is a principle object of the present invention to realize generative AI and large-language model (LLM) using storage power instead of computational power (“storage power” requires not only a large storage capability, but also an accurate and fast searching capability).

It is a further object of the present invention to provide a high-dimensional and large-scale vector database with high data-retrieval accuracy, fast performance and low system cost.

It is a further object of the present invention to provide a vector database supporting dynamic data.

It is a further object of the present invention to provide a vector database supporting dynamic metrics (i.e., vector-distance calculating algorithms).

In accordance with these and other objects of the present invention, the present invention discloses a vector databases based on three-dimensional (3-D) fusion.

### SUMMARY OF THE INVENTION

To overcome the limitations faced by the software approach (e.g., indexing), the present invention discloses an improved vector database. Unlike the conventional hardware whose processor is separated from storage, the present invention uses fusion, i.e., fuses processors into storage. To be more specific, the present invention lowers the processing circuit (i.e., vector-distance calculating circuit, or VDCC) down to the lowest level of the storage circuit (i.e., storage arrays). Because the storage array is the smallest building block of the storage circuit, the present invention has the smallest granularity (i.e., the amount of data processed by each VDCC), which is array-scale (˜Mb). This is much smaller than prior art, whose granularity is die-scale (˜Tb). By greatly reducing granularity and using massive parallelism, the present invention empowers accurate and fast brute-force search for the high-dimensional and large-scale vector database.

The preferred vector database is stored in a storage-processing body (SPB). The SPB comprises multiple storage-processing cores (SPC's), with each SPC comprising a plurality of storage-processing units (SPU's) and a minimum-distance search circuit (MDSC). Here, the SPC is the basic building block of the SPB (in the physical world), while the SPU is the basic building block of the SPC (from a design perspective). Each SPU comprises at least a storage array and a vector-distance calculating circuit (VDCC). The MDSC searches the minimum distance Dₘ from the distances Dᵢ calculated by all VDCC's. As a brute-force search, all vectors in the vector database are scanned (read out from storage arrays) and their distances from the query vector V_{q} (calculated by VDCC) are compared with each other, then the nearest neighbor Vₘ of V_{q} is found by searching the minimum distance Dₘ (performed by MDSC).

Accordingly, the present invention discloses a fused vector database, comprising an input for inputting a query vector and at least a storage-processing core (SPC) coupled with said input, wherein said SPC comprises: a plurality of storage-processing units (SPU's), each of said plurality of SPU's comprising at least a storage array for storing at least a data vector in said vector database, and a vector-distance calculation circuit (VDCC) for calculating a distance between said query vector and said data vector; and, a minimum-distance search circuit (MDSC) for searching at least a minimum distance from the distances calculated by the VDCC's in said plurality of SPU's.

Because brute-force search does not use any approximation methods (e.g., indexing), the present invention achieves good accuracy—the nearest neighbor found by the MDSC is the true nearest neighbor. This solves the problem of low accuracy for the high-dimensional vector database in prior art. Furthermore, because search is performed in parallel at all SPU's, the total search time is roughly independent of the scale Z of the vector database. No matter whether Z is trillion (10¹²), quadrillion (10¹⁵), or even higher, the search time is about the same (e.g., ˜10 ms). This is far more superior to prior art. Moreover, the present invention supports dynamic data (i.e. data vector in the vector database can be changed, added and/or deleted) and dynamic metrics (i.e., VDCC uses different vector-distance calculating algorithms in different scenarios).

The present invention further supports top-k (k>1) nearest neighbors. The MDSC is suitable to find the minimum distance Dₘ to a query vector V_{q}. To take full advantage of the MDSC, a reset circuit is used to reset the register storing Dₘ to a pre-determined value (typically a maximum value, e.g., every bit is reset to “1”) after Dₘ is found. This effectively takes Dₘ out of consideration for the next round of minimum-distance search. Thus, the minimum distance found at the next round is in fact the second minimum distance Dₘ₋₁. This process can be repeated to find all top-k nearest neighbors.

Conventionally, fusion (i.e., fusing processors into storage) is realized through two-dimensional (2-D) integration, i.e., the storage circuit and the logic circuit are integrated side-by-side on a same substrate. This leads to two problems: the first problem is a larger die size (storage arrays become less dense) and a higher cost; the second problem is that, because the manufacturing processes for the storage circuit and the logic circuit are not compatible, integrating them on the same substrate leads to a complex manufacturing process and an even higher cost. To solve these problems, the present invention realizes fusion through three-dimensional (3-D) integration. In a preferred SPU based on 3-D integration (i.e., 3-D SPU), the storage circuit and the logic circuit are disposed on two physical planes: storage array are disposed on a first plane, while VDCC and MDSC are disposed on a second plane. The first and second planes are vertically stacked and communicatively coupled by inter-plane connections. One role of these inter-plane connections is to provide large-bandwidth electrical connections between two planes. Another role is to provide large-strength mechanical connections between two planes.

Accordingly, the present invention discloses a three-dimensional (3-D) vector database, comprising an input for inputting a query vector and at least a storage-processing core (SPC) coupled with said input, wherein said SPC comprises: a plurality of storage-processing units (SPU's), each of said plurality of SPU's comprising at least a storage array for storing at least a data vector in said vector database, and a vector-distance calculation circuit (VDCC) for calculating a distance between said query vector and said data vector; at least a semiconductor substrate, wherein said VDCC is disposed on said semiconductor substrate; said storage array is disposed above said VDCC; said VDCC and the projection of said storage array on said semiconductor substrate at least partially overlap; said VDCC and said storage array are communicatively coupled.

The SPC based on 3-D integration (i.e., 3-D SPC) takes two forms: one is a storage-processing die, while the other is a storage-processing stack (which comprises bonded dice). The preferred storage-processing die is a single die and uses monolithic 3-D integration, i.e., its storage circuit (including 3-D memory arrays) is vertically stacked above the logic circuit (including VDCC, MDSC, and the peripheral circuits of the 3D-M arrays), both in the same die. On the other hand, the preferred storage-processing stack comprises several bonded dice, e.g., a storage die (comprising storage arrays disposed on a first substrate) and a logic die (comprising VDCC, MDSC and even portions of the peripheral circuits of the storage arrays, all disposed on a second substrate). They are vertically stacked and bonded. In the preferred storage-processing stack, the storage could be conventional 2-D memory (such as RAM, ROM, or NVM) or 3-D memory (3D-M). One storage-processing stack of importance is a storage-processing doublet, which comprises two (a pair of) face-to-face dice bonded by hybrid bonding.

Like flash memory and solid-state drives, the preferred SPC's can be packaged into storage-processing cards; the storage-processing cards can be packaged into storage-processing drives; and, the storage-processing drives can be packaged into storage-processing clusters. They form a storage-processing hierarchy. Each level of the storage-processing hierarchy could have its own vector-computing circuit, e.g., VDCC, filtering circuit, and sorting circuit. The vector-computing circuit at a lower level is generally less complex than the one at a higher level. Moreover, the selection criterion at a lower level is more lenient.

### BRIEF DESCRIPTION OF DRAWINGS

FIG. 1A is a diagram showing a vector database; FIG. 1B is a diagram showing a simplified vector space with two dimensions; FIG. 1C is a diagram showing an indexing algorithm (prior art).

FIG. 2A is a block diagram of a preferred storage-processing core (SPC) in a preferred fused vector database; FIG. 2B is a block diagram of a preferred storage-processing unit (SPU) in the preferred SPC.

FIG. 3 is perspective view of a preferred three-dimensional (3-D) SPU.

FIGS. 4A-4B are cross-sectional views of two preferred storage-processing dice.

FIGS. 5A-5B are cross-sectional views of two preferred storage-processing stacks.

FIGS. 6A-6C are block diagrams of three preferred 3-D SPU's.

FIGS. 7A-7C are layout views of three preferred 3-D SPU's.

FIGS. 8A-8B are circuit diagrams of two preferred vector-distance calculation circuits (VDCC's).

FIG. 9 is a block diagram of a preferred reconfigurable SPU.

FIG. 10 is a circuit diagram of a preferred reconfigurable VDCC.

FIG. 11 is a circuit diagram of a preferred minimum-distance search circuit (MDSC).

FIG. 12 is a circuit diagram of another preferred MDSC with a reset circuit.

FIG. 13 is a flow diagram of a preferred minimum-distance searching algorithm.

FIG. 14 is a preferred storage-processing hierarchy.

FIG. 15 is a block diagram of a preferred hybrid VDCC.

FIGS. 16A-16D are block diagrams of four preferred hybrid VDCC's.

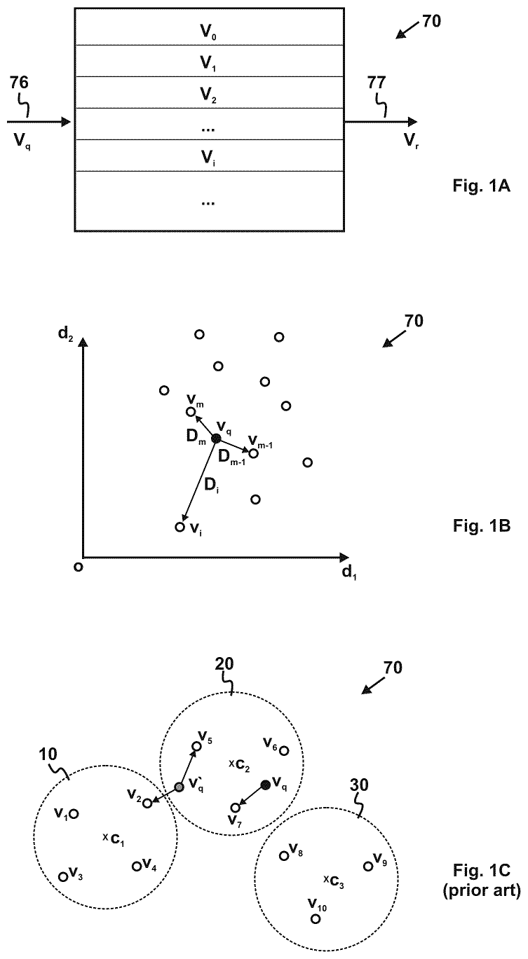

It should be noted that all the drawings are schematic and not drawn to scale. Relative dimensions and proportions of parts of the device structures in the figures have been shown exaggerated or reduced in size for the sake of clarity and convenience in the drawings. The same reference symbols are generally used to refer to corresponding or similar features in the different embodiments. References to numbers without subscripts or suffixes are understood to reference all instance of subscripts and suffixes corresponding to the referenced number. The symbol “/” means the relationship of “and” or “or”.

### DETAILED DESCRIPTION OF THE INVENTION

As used herein, the phrase “vector database” could refer to either vector database in the mathematical sense (i.e., an organized collection of vectors), or the hardware/software used to implement a vector database (hardware includes processor, storage and associated architecture; and, software includes the index file and the associated indexing algorithms). The present invention does not differentiate them.

As used herein, the phrases “storage” and “memory” are used interchangeably and in their broadest sense to mean any semiconductor device which can store information. Embodiments may include random-access memory (RAM), read-only memory (ROM), non-volatile memory (NVM) and three-dimensional memory (3D-M). The phrases “storage array” and “memory array” are also used interchangeably. Storage/memory array is the basic building block of a storage/memory die. It means a collection of all memory cells sharing at least one address line. The phrase “storage-processing body” is used in its broadest sense to mean any storage with built-in processing capability. Examples include storage-processing core (SPC), storage-processing card, storage-processing drive, and storage-processing cluster.

As used herein, the phrase “core” is used in its broadest sense to mean a mechanically-stable entity, i.e., in a direction perpendicular to its substrate, its mechanical strength is too strong to be pried open by external mechanical forces (before breaking the substrate). Storage-processing core (SPC) is the basic building block of the storage-processing body in the physical world. SPC takes two forms: one is a single die, the other is a stack (containing several bonded dice, e.g., a doublet).

As used herein, the phrase “on a substrate” means that the active elements (e.g., transistors, memory cells) or portions thereof are located in the substrate, even though the interconnects coupling them are located above the substrate. The phrase “above a substrate” means that the active elements (e.g., transistors, memory cells) are located above the substrate, not in the substrate. Unless being pointed out specifically, the phrases “up (on, above)” “down (below, beneath)” means relative positions when the die is placed upward, i.e., the substrate is at the bottom. Even when a die is flipped, these phrases are still used in the same sense as those before the die is flipped.

As used herein, the phrase “plane” means a plane in an abstract sense. It may comprise physical structures with a finite thickness. For example, a plane may comprise a memory array with multiple memory levels, or a circuit with multiple interconnect levels. The phrase “a first plane is stacked on a second plane” means first physical structures (e.g., storage arrays) with a first finite thickness are stacked on second physical structures (e.g., substrate circuits) with a second finite thickness.

To overcome the limitations faced by the software approach (e.g., indexing), the present invention discloses an improved vector database. Unlike the conventional hardware whose processor is separated from storage, the present invention uses fusion, i.e., fuses processors into storage. To be more specific, the present invention lowers the processing circuit (i.e., vector-distance calculating circuit, or VDCC) down to the lowest level of the storage circuit (i.e., storage arrays). Because the storage array is the smallest building block of the storage circuit, the present invention has the smallest granularity (i.e., the amount of data processed by each VDCC), which is array-scale (˜Mb). This is much smaller than prior art, whose granularity is die-scale (˜Tb). By greatly reducing granularity and using massive parallelism, the present invention empowers accurate and fast brute-force search for the high-dimensional and large-scale vector database.

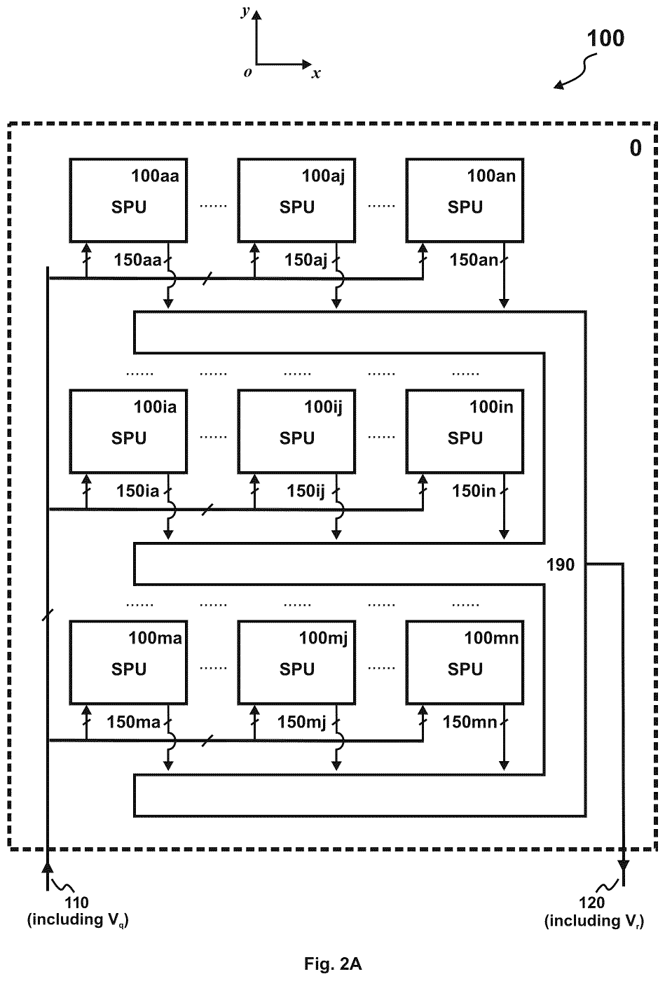

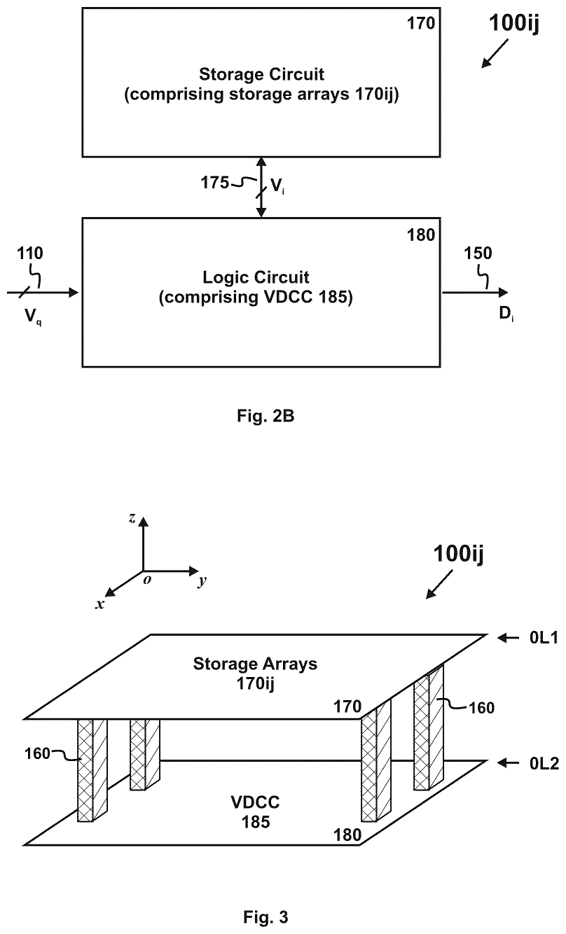

Referring now to FIGS. 2A-2B, a preferred storage-processing core (SPC) 100 in the preferred vector database is disclosed. The preferred vector database is stored in a preferred storage-processing body, which comprises multiple SPC's 100. The preferred SPC 100 (FIG. 2A) is the basic building block of the storage-processing body (in the physical world). It is mechanically-stable entity. The SPC 100 not only can store data (vector database), but also can process data (calculate vector distance). The data are stored locally and in close proximity to the processing circuit. The inputs 110 of the SPC 100 include the query vector V_{q}, and outputs 120 include the result vector Vᵣ. The SPC 100 is disposed on a semiconductor substrate 0. It comprises m×n storage-processing units (SPU's 100aa . . . 100ij . . . 100mn) and a minimum-distance search circuit (MDSC) 190.

The SPU 100ij is the basic building block of the SPC 100 (from a design perspective). Each SPU 100ij comprises a storage circuit 170 and a logic circuit 180 (FIG. 2B). The storage circuit 170 comprises storage arrays 170ij, which stores at least a data vector Vᵢ 175 from the vector database. The logic circuit 180 comprises a vector-distance calculation circuit (VDCC) 185. The inputs 110, 175 of the VDCC 185 include the query vector V_{q} and the data vector Vᵢ, while the output 150 (150aa . . . 150mn in FIG. 2A) includes the vector distance Dᵢ. The MDSC 190 compares the vector distances Dᵢ from all SPU's (100aa . . . 100mn) and searches for a minimum distance Dₘ and the associated data vector Vₘ, which is the resultant vector Vᵣ.

Because brute-force search does not use any approximation methods (e.g., indexing), the present invention achieves good accuracy—the nearest neighbor found by the MDSC is the true nearest neighbor. This solves the problem of low accuracy for the high-dimensional vector database in prior art. Furthermore, because search is performed in parallel at all SPU's, the total search time is roughly independent of the scale Z of the vector database. No matter whether Z is trillion (10¹²), quadrillion (10¹⁵), or even higher, the search time is about the same (e.g., ˜10 ms). This is far more superior to prior art.

Conventionally, fusion (i.e., fusing processors into storage) is realized through two-dimensional (2-D) integration, i.e., the storage circuit and the logic circuit are integrated side-by-side on a same substrate. This leads to two problems: the first problem is a larger die size (storage arrays become less dense) and a higher cost; the second problem is that, because the manufacturing processes for the storage circuit and the logic circuit are not compatible, integrating them on the same substrate leads to a complex manufacturing process and an even higher cost. To solve these problems, the present invention realizes fusion through three-dimensional (3-D) integration.

In FIG. 3, a preferred SPU 100ij based on 3-D integration (i.e., 3-D SPU) is disclosed. Its storage circuit 170 (including storage arrays 170ij) is disposed on a first plane 0L1, while the logic circuit 180 (including VDCC 185) is disposed on a second plane 0L2. The first and second planes are vertically stacked and communicatively coupled by inter-plane connections 160. One role of these inter-plane connections 160 is to provide large-bandwidth connections between two planes 0L1, 0L2. Another role is to provide mechanically-stable connections between two planes 0L1, 0L2.

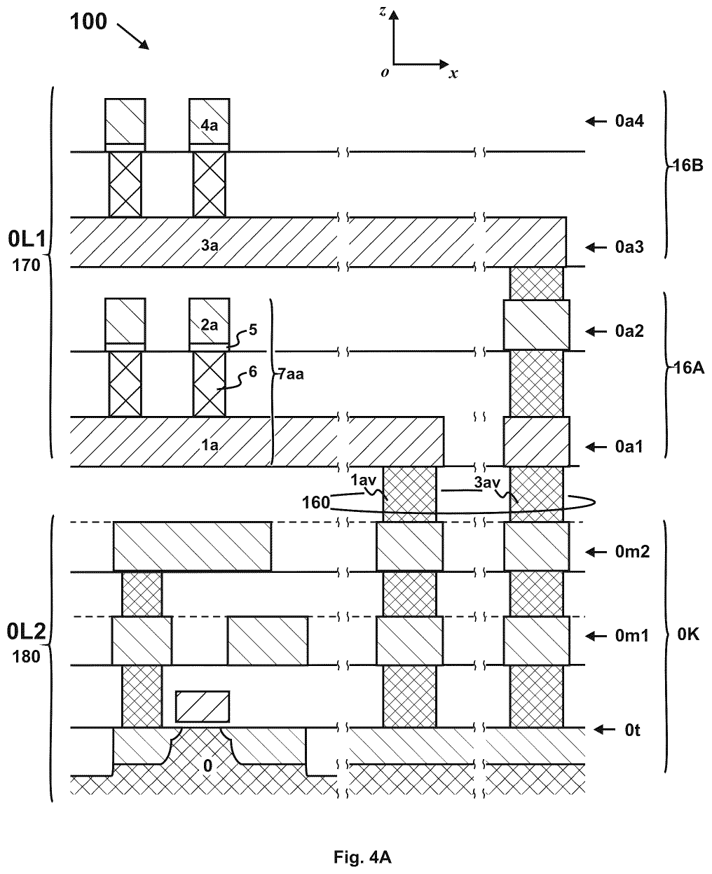

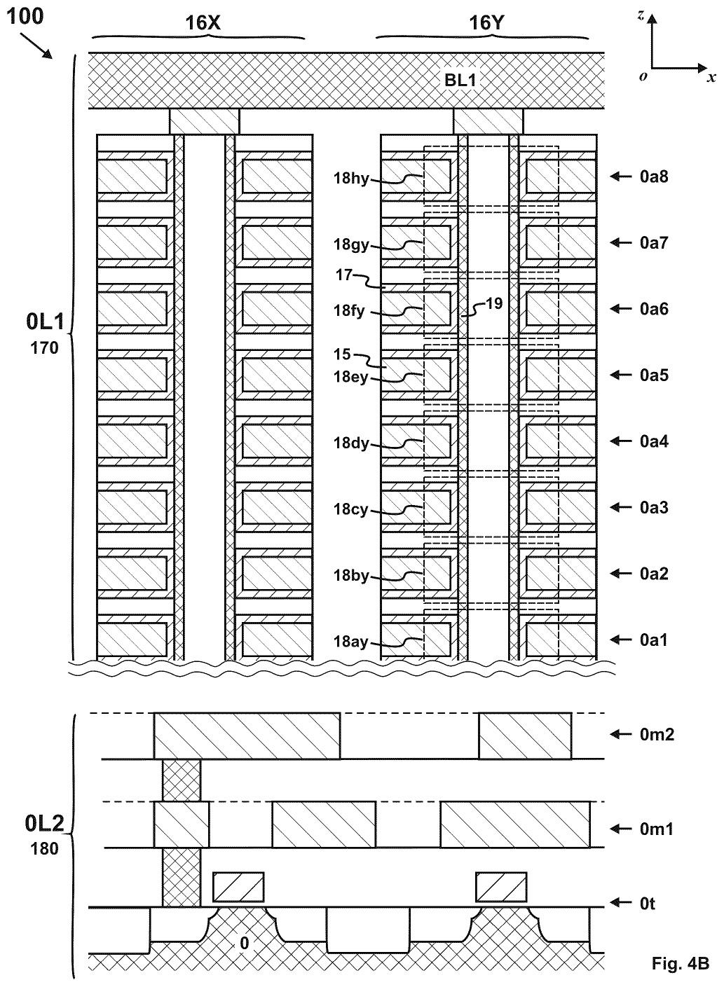

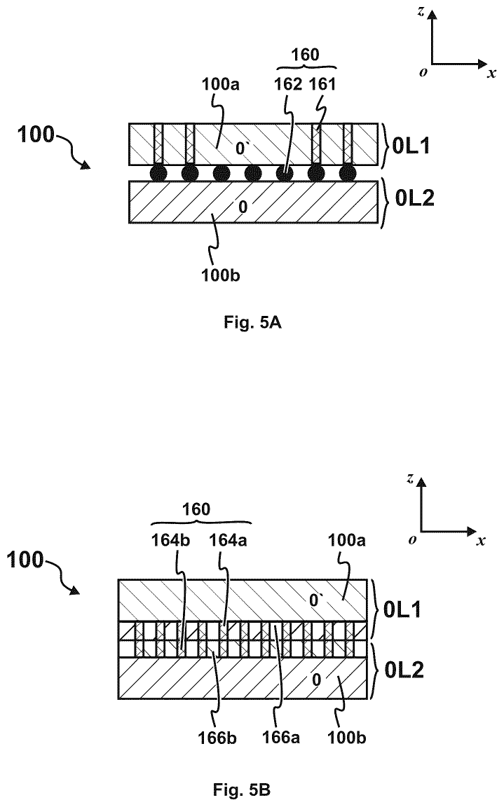

The SPC based on 3-D integration (i.e., 3-D SPC) 100 takes two forms: one is a storage-processing die (FIGS. 4A-4B), while the other is a storage-processing stack (FIGS. 5A-5B). The preferred storage-processing die is a single die and uses monolithic 3-D integration, i.e., its storage circuit 170 (including 3-D memory arrays 100ij) is vertically stacked above the logic circuit 180 (including VDCC 185, MDSC 190, and the peripheral circuits of the 3D-M arrays), both in the same die. On the other hand, the preferred storage-processing stack comprises several bonded dice, e.g., a storage die 100a (comprising storage arrays disposed on a first substrate 0′) and a logic die 100b (comprising VDCC 185, MDSC 190 and even portions of the peripheral circuits of the storage arrays, all disposed on a second substrate 0) are vertically stacked and bonded. In the preferred storage-processing stack, the storage could be conventional 2-D memory (such as RAM, ROM, or NVM) or 3-D memory (3D-M). For example, the storage circuit 170 could be DRAM, then the present invention is a main memory with built-in MDSC; the storage circuit 170 could be flash, then the present invention is an external memory with built-in MDSC; the storage circuit 170 could be 3D-XPoint, then the present invention is a persistent memory with built-in MDSC.

Referring now to FIGS. 4A-4B, two preferred storage-processing dice 100 are shown. In the preferred storage-processing die 100, because the storage circuit 170 is stacked on the logic circuit 180, the fusion between the storage circuit 170 and the logic circuit 180 would not increase the die size. This is quite an improvement over the conventional 2-D integration. The preferred storage-processing die 100 comprises 3-D memory (3D-M) arrays 170ij. Unlike a conventional memory whose memory cells are disposed on a 2-D plane, the memory cells in a 3D-M array 170ij are disposed in a 3-D space. These 3D-M arrays 170ij are monolithically integrated on a substrate circuit OK, which is disposed on a semiconductor substrate 0. Note that the logic circuit 180 (including VDCC 185, MDSC 190 and the peripheral circuits of the 3D-M arrays 170ij) are portions of the substrate circuit OK.

[54] Based on its physical structure, 3D-M can be categorized into horizontal 3D-M (3D-MH) and vertical 3D-M (3D-Mv). In a 3D-MH, all address lines are horizontal. The memory cells form a plurality of horizontal memory levels which are vertically stacked above each other. A well-known 3D-MH is 3D-XPoint. In a 3D-Mv, at least one set of the address lines are vertical. The memory cells along these vertical address lines form a plurality of vertical memory strings which are placed side-by-side on/above the substrate. A well-known 3D-Mv is 3D-NAND. In general, the 3D-MH (e.g., 3D-XPoint) is faster, while the 3D-Mv (e.g., 3D-NAND) is denser.

Based on its functionality, 3D-M can be categorized into 3D-RAM (random-access memory) and 3D-ROM (read-only memory). The 3D-RAM can be used as cache. The 3D-ROM can store data for long term. It is also referred to as 3-D non-volatile memory (NVM). Exemplary memory types that are suitable for the 3D-M include memristor, resistive RAM (RRAM or ReRAM), phase-change memory (PCM), programmable metallization cell (PMC) memory, conductive-bridging random-access memory (CBRAM), and the like.

In FIG. 4A, the storage-processing die 100 comprises a logic circuit 180 and a storage circuit 170. The logic circuit 180 (including VDCC 185), whose physical location is at the second plane 0L2, is a portion of a substrate circuit OK (including transistors 0t and substrate interconnects 0m1, 0m2). The storage circuit 170, whose physical location is at the first plane 0L1, includes 3D-MH array(s). In this example, the storage circuit 170 comprises four address-line layers 0a1-0a4. Each address-line layer (e.g. 0a1) comprises a plurality of address lines (e.g. 1a). These address-line layers 0a1-0a4 form two memory levels 16A, 16B, with the memory level 16A stacked on the substrate circuit OK and the memory level 16B stacked on the memory level 16A. Memory cells (e.g., 7aa) are disposed at the intersections between two address lines (e.g., 1a, 2a). The memory levels 16A, 16B are communicatively coupled with the substrate circuit OK through contact vias 1av, 3av, which form inter-plane connections 160. Note that contact vias 1av, 3av are intra-die connections.

In the storage circuit 170 of FIG. 4A, the memory cell 7aa comprises a programmable layer 5 and a diode layer 6. The programmable layer 5 could be an antifuse layer (which can be programmed once and used for the 3D-OTP) or a resistive RAM (RRAM) layer (which can be re-programmed and used for the 3D-MTP). The diode layer 6 is broadly interpreted as any layer whose resistance at the read voltage is substantially lower than when the applied voltage has a magnitude smaller than or a polarity opposite to that of the read voltage. To those skilled in the art, diode is also referred to as selector, steering element, one-way switch, and the like.

FIG. 4B is similar to FIG. 4A, except that the 3D-M array is a 3D-My array. The storage circuit 170 comprises eight vertically stacked horizontal address-line layers 0a1-0a8. Each horizontal address-line layer (e.g. 0a5) comprises a plurality of horizontal address lines (e.g. 15). The storage circuit 170 also comprises a set of vertical address lines 19, which are perpendicular to the surface of the substrate 0. For reason of simplicity, the inter-plane connections 160 between the 3D-My arrays 170 and the substrate circuit OK are not shown. They are well known to those skilled in the art.

The preferred 3D-My array in FIG. 4B is based on vertical transistors or transistor-like devices. It comprises a plurality of vertical memory strings 16X, 16Y placed side-by-side. Each memory string (e.g. 16Y) comprises a plurality of vertically stacked memory cells (e.g. 18ay-18hy). Each memory cell (e.g. 18fy) comprises a vertical transistor, which includes a gate (acts as a horizontal address line) 15, a storage layer 17, and a vertical channel (acts as a vertical address line) 19. The storage layer 17 could comprise oxide-nitride-oxide layers, oxide-poly silicon-oxide layers, or the like. Alternatively, the preferred 3D-My array may be based on diodes or diode-like devices.

Referring now to FIGS. 5A-5B, two preferred storage-processing stacks 100 are shown. The preferred stack 100 comprises a first die 100a (including the storage circuit 170) and a second die 100b (including the logic circuit 180), which are stacked and bonded. Through vertical stacking, the fusion of the storage circuit 170 and the logic circuit 180 would not increase the die size. More importantly, because the storage circuit 170 and the logic circuit 180 are respectively disposed on the storage die 100a and the logic die 100b, they can be made by different manufacturing processes, thus simplifying the process design and further lowering the cost.

The preferred storage-processing stack of FIG. 5A uses face-to-back bonding, i.e. the face of the second die 100b is bonded to the back of the first die 100a. During manufacturing process, through-silicon vias (TSV's) 161 are etched through the first die 100a. Both first and second dice 100a, 100b face upward (+z direction) at bonding. The first die 100a is communicatively coupled with the second die 100b through the micro-bumps 162. The TSV's 161 and the micro-bumps 162 realize the inter-die (plane) connections 160.

The preferred storage-processing stack of FIG. 5B uses face-to-face bonding, i.e., the first and second dice 100a, 100b are bonded face-to-face. To be more specific, the first die 100a is flipped and faces downward (i.e. along the −z direction), while the second die 100b faces upward (i.e. along the +z direction). This face-to-face bonded stack (pair) is also referred to as doublet. The preferred doublet 100 uses hybrid-bonding technology and two dice 100a, 100b are bonded by metal-to-metal (e.g., Cu-Cu) bonding. During manufacturing process, a first dielectric layer 166a is deposited on top of the first die 100a and first vias 164a are etched in the first dielectric layer 166a. Then a second dielectric layer 166b is deposited on top of the second die 100b and second vias 164b are etched in the second dielectric layer 166b. After flipping the first die 100a and aligning the first and second vias 164a, 164b, the first and second dice 100a, 100b are bonded. The contacted first and second vias 164a, 164b realize the inter-die (plane) connections 160. Because there is no semiconductor substrate between them, the first and second dice 100a, 100b are in close proximity and therefore, the first and second vias 164a, 164b can be made small and numerous. As a result, the inter-die (plane) connections 160 have a large bandwidth. It should be well known to those skilled in the art that, besides metal-to-metal bonding, dielectric-to-dielectric bonding or dielectric-to-semiconductor bonding may also be used.

Both preferred embodiments in FIGS. 5A-5B may use wafer-scaling bonding, i.e., two wafers are first bonded before being diced. Accordingly, the first and second dice 100a, 100b could have the same die sizes, and all edges of the first and second dice 100a, 100b are aligned. For example, the left edge of the first die 100a is aligned with the left edge of the second die 100b; and, the right edge of the first die 100a is aligned with the right edge of the second die 100b.

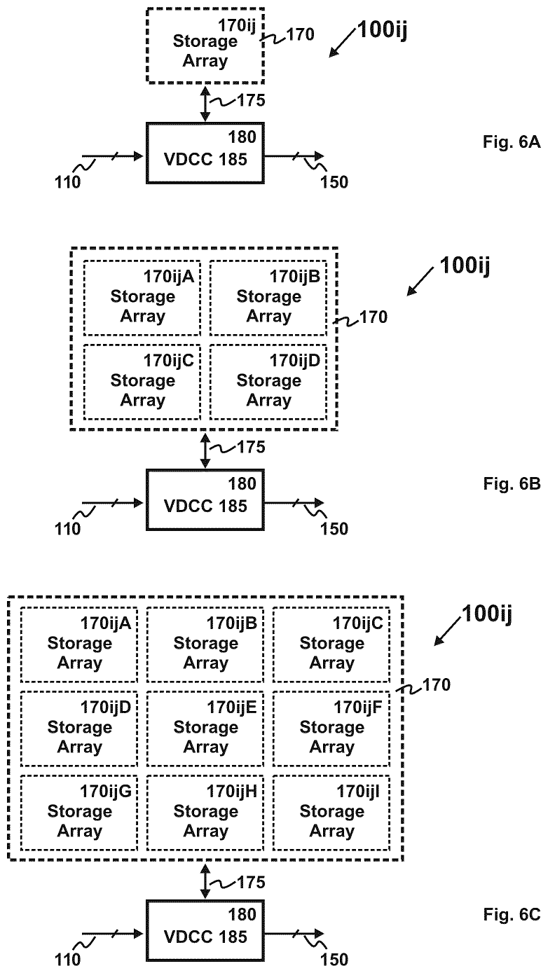

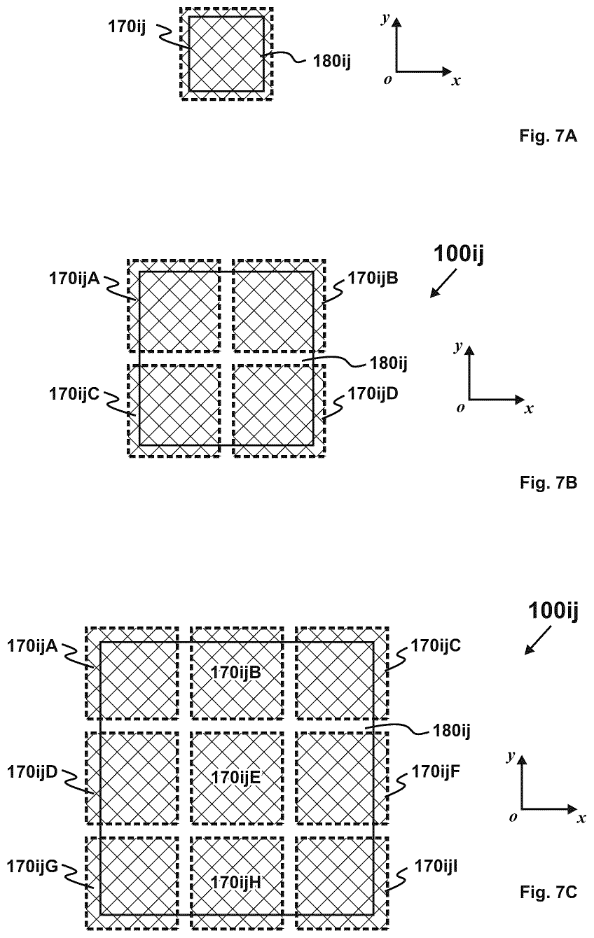

Referring now to FIGS. 6A-7C, three preferred 3-D SPU 100ij are shown. In these preferred embodiments, a VDCC 185 serves different number of storage arrays 170ij.

In FIG. 6A, the VDCC 185 serves a single storage array 170ij, i.e. it calculates vector distance for the data vectors stored in a single storage array 170ij. In FIG. 6B, the VDCC 185 serves four storage arrays 170ijA-170ijD, i.e. it calculates vector distance for the data vectors stored in four storage arrays 170ijA-170ijD. In FIG. 6C, the VDCC 185 serves nine storage arrays 170ijA-170ijI, i.e. it calculates vector distance for the data vectors stored in nine storage arrays 170ijA-170ijI. As will become apparent in FIGS. 7A-7C, the more storage arrays it serves, a larger area and more functionalities the VDCC 185 will have. In FIGS. 6A-7C, because they are located on a different plane than the VDCC 185 (referring to FIG. 3), the storage arrays 170ij are drawn in dashed lines.

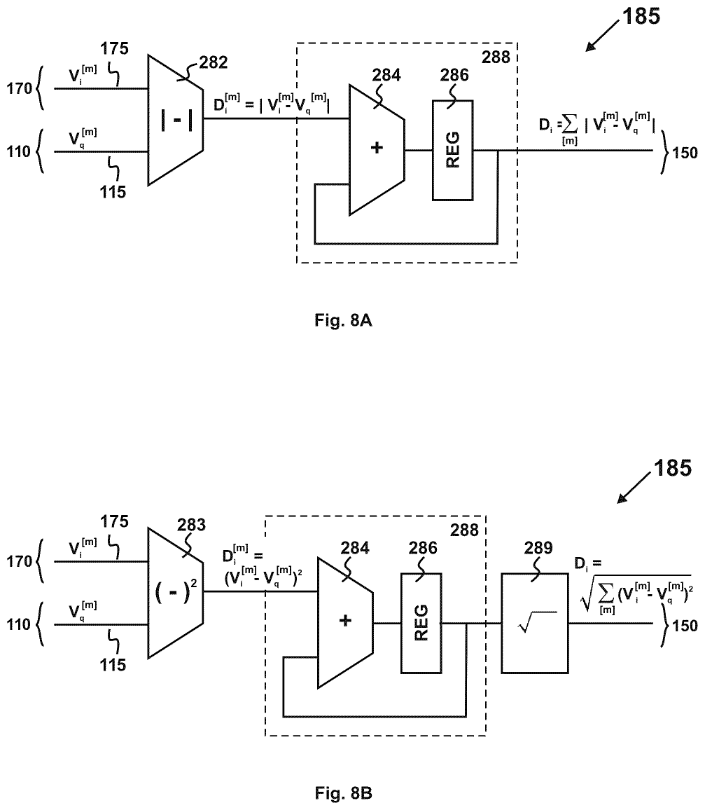

FIGS. 7A-7C illustrate the projections of the storage arrays 170 (physically located on the first plane 0L1, drawn in dashed lines) on the second plane 0L2 with respect to the VDCC 185. The preferred embodiment of FIG. 7A corresponds to that of FIG. 6A. Its VDCC 185 is covered by the storage array 170ij. In this preferred embodiment, the VDCC pitch is equal to that of the storage array. Because its area is smaller than the footprint of a storage array, the VDCC 185 in FIG. 7A has limited functionalities. It can be used to implement simple distance-calculating algorithms, as shown in FIG. 8A.

FIGS. 7B-7C discloses two complex VDCC's 185. These complex VDCC's can be used to implement complex distance-calculating algorithms, as shown in FIG. 8B and FIGS. 9-10. The preferred embodiment of FIG. 7B corresponds to that of FIG. 6B. Its VDCC 185 is covered by four storage arrays 170ijA-170ijD. Below the four storage arrays 170ijA-170ijD, the VDCC 185 can be laid out freely. Because the VDCC pitch is twice as much as that of the storage arrays, the VDCC 185 is four times larger than the footprint of each storage array and therefore, has more complex functionalities.

The preferred embodiment of FIG. 7C corresponds to that of FIG. 6C. Its VDCC 185 is covered by nine storage arrays (170ijA . . . 170ijI). Below the nine storage arrays (170ijA . . . 170ijI), the VDCC 185 can be laid out freely. Because the VDCC pitch is three times as much as that of the storage arrays, the VDCC 185 is nine times larger than the footprint of each storage array and therefore, has even more complex functionalities.

Referring now to FIGS. 8A-10, several preferred VDCC's 185 are disclosed. FIGS. 8A-8B discloses two preferred VDCC's 185 to implement Manhattan distance and Euclidean distance, respectively. The first preferred VDCC 185 of FIG. 8A calculates Manhattan distance. A sub-abs unit 282 calculates a difference Dᵢ^{[m]}=|Vᵢ^{[m]}−V_{q}^{[m]}| (i.e., absolute value of subtraction), where V_{q}^{[m]} is the value of the query vector V_{q} 115 at the mth dimension (from the input 110); Vᵢ^{[m]} is the value of the data vector Vᵢ 175 at the mth dimension (from the storage circuit 170). Then an accumulator 288 (including an adder 284 and a register 286) sums the Dᵢ^{[m]} for all m dimensions. Performing only subtraction (with absolute value), this preferred VDCC 185 could be realized by a relatively simple circuit. For example, the VDCC 185 in FIG. 7A may be used.

The second preferred VDCC 185 of FIG. 8B calculates Euclidean distance. A sub-sqr unit 283 calculates a difference Dᵢ^{[m]}=(Vᵢ^{[m]}−V_{q}^{[m]})² (i.e., square of subtraction). Then an accumulator 288 sums the Dᵢ^{[m]} for all m dimensions, before a square-root operation 289 is performed. Because it involves square and square-root operations, the second preferred VDCC 185 could be realized by a relatively complex circuit. For example, the VDCC 185 in FIG. 7B may be used.

It is well known to those skilled in the art that, besides Manhattan distance and Euclidean distance, other distance-calculating algorithms can be used. They include Chebyshev distance, Minkowski distance, Cosine similarity, Haversine distance, Pearson correlation coefficient, Earth mover's distance (EMD), Jaccard similarity, Sorensen-Dice index, Hamming distance, inner product, and the like.

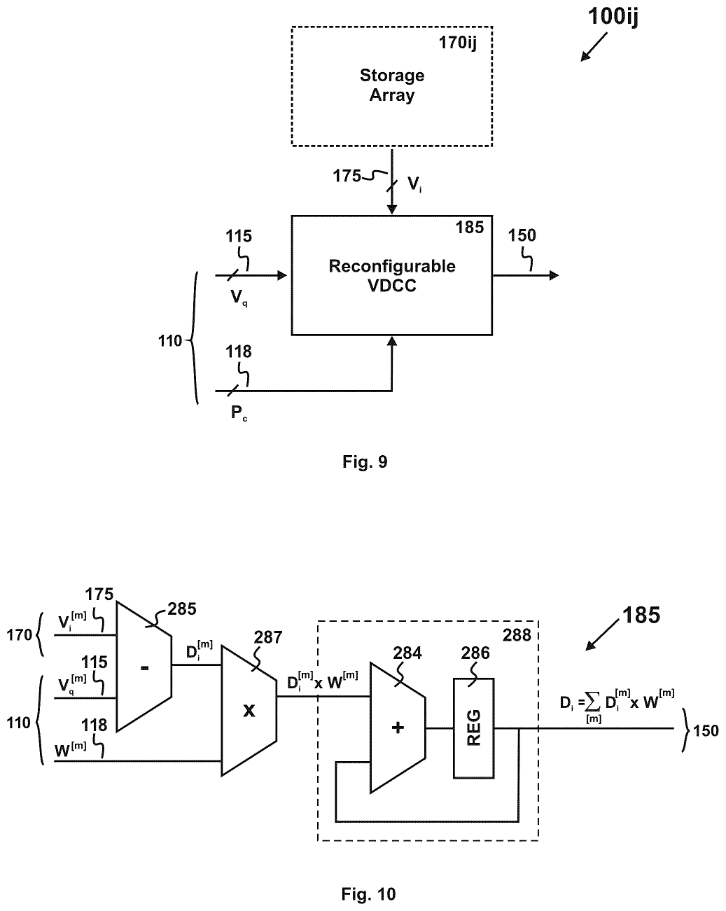

In general, different distance-calculating algorithm is preferred in different scenarios. To support dynamic metrics (i.e., use different distance-calculating algorithm in different scenarios), the present invention further discloses a reconfigurable vector database. As shown in FIG. 9, its SPU is reconfigurable SPU 100ij and its VDCC is a reconfigurable VDCC 185. The distance-calculating algorithm performed by the reconfigurable VDCC 185 is configured by the configuration parameters Pc 118, which is also a part of the input 110. Like in FIG. 2A, the input 110 feeds into every reconfigurable SPU 100ij in an SPC 100. All reconfigurable SPU's in the SPC 100 are configured together to a different distance-calculating algorithm at the same time. For example, at time t₁, all reconfigurable SPU's are configured to a first distance-calculating algorithm; at time t₂, all reconfigurable SPU's are configured to a second distance-calculating algorithm; and so on.

FIG. 10 illustrates a preferred reconfigurable VDCC 185. It uses a weighted-distance algorithm. A subtractor 285 calculates a difference Dᵢ^{[m]}=V_{q}^{[m]}−Vᵢ^{[m]}. Then a multiplier 287 multiplies the difference Dᵢ^{[m]} with the weight W^{[m]}, which comes from the configuration parameters P_{c} 118. The vector distance D is a weighted sum, i.e., the sum of Dᵢ^{[m]}*W^{[m]} for all m dimensions. By adjusting the weights W^{[m]}, different distance-calculating algorithms can be applied to each SPU 100ij in the SPC 100. This is particularly useful when optimizing the searching algorithm.

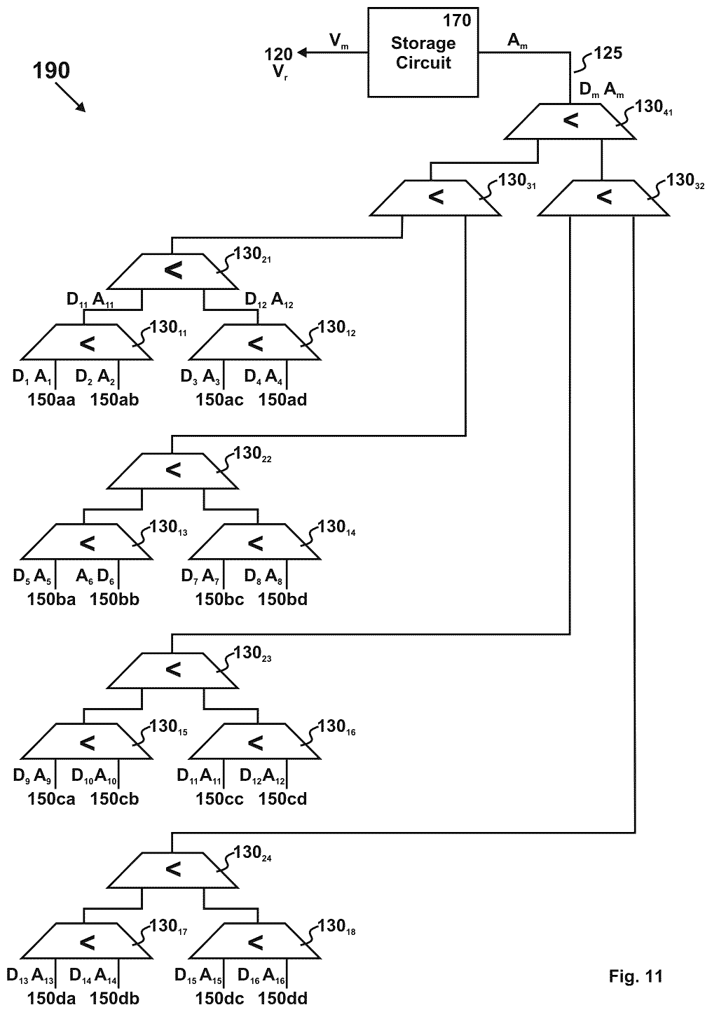

Referring now to FIGS. 11-13, several preferred MDSC's 190 are disclosed. The first preferred MDSC 190 of FIG. 11 uses a binary-tree comparison circuit to find the minimum distance Dm. In this example, there are 16 SPU's, whose outputs 150aa-150dd are vector distances D₁-D₁₆. These vector distances D₁-D₁₆ are compared in pairs at comparators 130₁₁-130₁₈. Each comparator (e.g., 130₁₁) has four inputs (e.g., D₁, A₁; D₂, A₂) and two outputs (e.g., D₁₁, A₁₁), where D₁ is the output from a first SPU and A₁ is the address of the first SPU; D₂ is the output from a second SPU and A₂ is the address of the second SPU; D₁₁ is the smaller of D₁ and D₂, while A₁₁ is the address associated with D₁₁. After comparing in pairs at the comparators 130₁₁-130₁₈, D₁₁-D₁₈ are sent to a higher-level comparators 130₂₁-130₂₄ to do another round of comparison. This process is repeated until reaching the highest-level comparator 130₄₁, wherein the minimum vector distance Dₘ and its associated minimum address Aₘ are found. This minimum address Aₘ is then sent to the storage circuit 170 to find the minimum-distance vector Vₘ, which is the nearest neighbor (i.e., the resultant vector Vᵣ 120) to the query vector V_{q}.

The example disclosed in FIG. 11 is a simplified case where the storage circuit 170 in each SPU 100ij stores a single data vector. In case that the storage circuit 170 stores X (X is a positive integer) data vectors, these data vectors are read out in X cycles during brute-force search. For example, within a first cycle, a first set of data vectors are read out from all SPU's and the MDSC 190 of FIG. 11 finds Dₘ₁ for the first cycle (to be stored in a Dₘ₁ register); within a second cycle, a second set of data vectors are read out from all SPU's and the MDSC 190 finds Dₘ₂ for the second cycle (to be stored in a Dₘ₂ register); and so on. After N cycles, Dₘ₁, Dₘ₂ . . . are compared to find Dₘ for the whole vector database.

The present invention further supports top-k (k>1) nearest neighbors. The MDSC is suitable to find the minimum distance Dₘ to a query vector V_{q}. To take full advantage of the MDSC, a reset circuit is used to reset the register storing Dₘ to a pre-determined value (typically a maximum value, e.g., every bit is reset to “1”) after Dₘ is found. This effectively takes Dₘ out of consideration for the next round of minimum-distance search. Thus, the minimum distance found at the next round is in fact the second minimum distance Dₘ₋₁. This process can be repeated to find all top-k nearest neighbors.

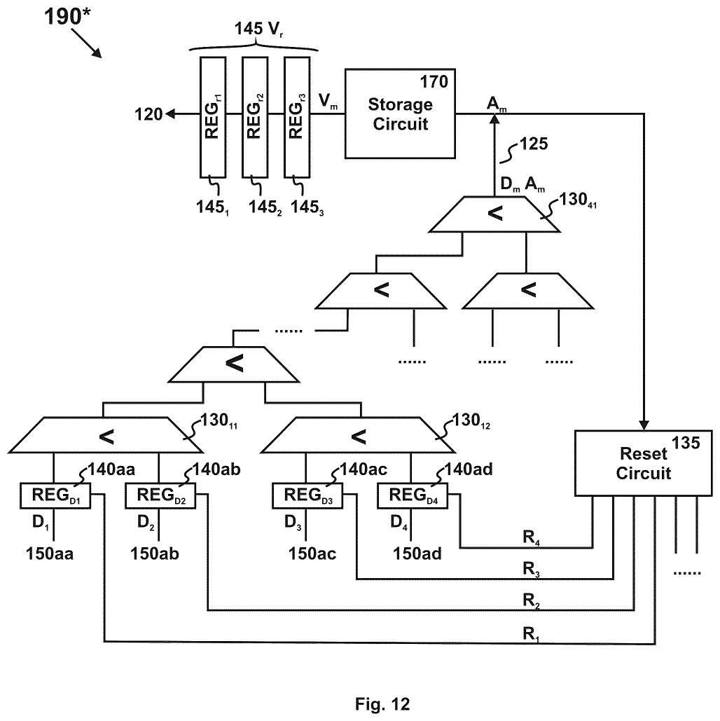

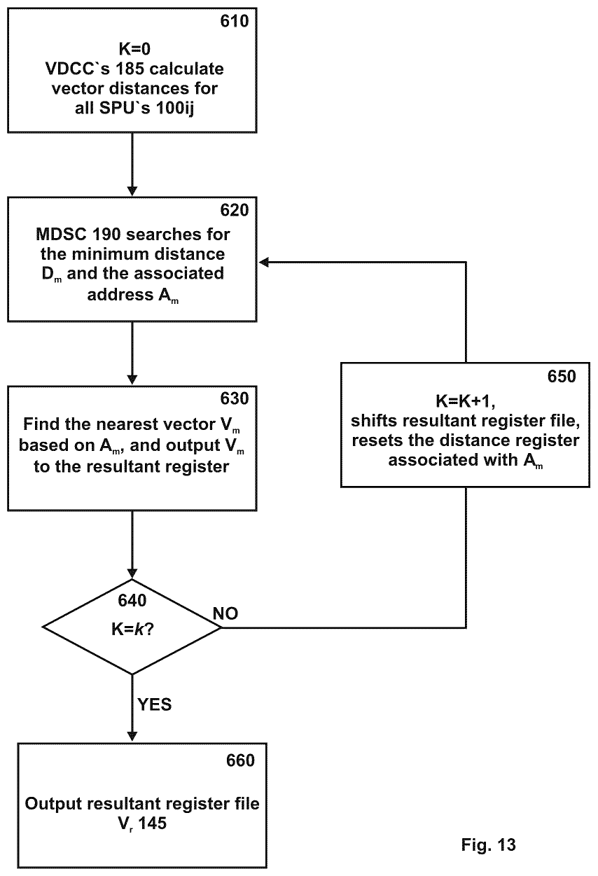

FIGS. 12-13 disclose a preferred MDSC 190* to find the top-k nearest neighbors and related methods. For this preferred MDSC 190* (FIG. 12), each VDCC output (e.g., 150aa, or, vector distance D₁) is stored in a distance register (e.g., 140aa, or, REG_{D1}). This preferred MDSC 190* further comprises a reset circuit 135. Its input is the address Am associated with the minimum distance Dₘ, and its outputs R1, R2 . . . are respectively connected with the reset port of the distance registers REG_{D1} 140aa, REG_{D2} 140ab . . . . After finding Aₘ and outputting Vₘ, the reset circuit 135 resets the distance register associated with the address Aₘ to a pre-determined value (typically the maximum distance, e.g., every bit of this distance register is reset to “1”).

The searching loop for Vₘ (FIG. 13) is same as that in FIG. 11: VDCC's 185 calculate vector distances D for all SPU's (step 610); MDSC 190 searches for the minimum distance Dₘ and the associated address Aₘ (step 620); from Aₘ, find Vₘ in the storage circuit 170 (step 630). Once Vₘis found, the next step is to find Vₘ₋₁ (steps 640-650). A key step is to reset the distance register associated with Aₘ to a pre-determined value (e.g., all “1”s). For example, D₂ is the minimum distance and Aₘ points to 150ab. The reset circuit 135, which is a decoder that uses Aₘ as inputs, sets the signals on wire R₂ to high. This will reset the distance register REG_{D2} 140ab (step 650). As Vₘ is taken out of consideration, a second searching loop (steps 620-630) will result in Vₘ₋₁. After Vₘ₋₁ is taken out of consideration, a third searching loop (steps 620-630) will result in Vₘ₋₂. Continue the searching loops until the top-k nearest neighbors are found (step 660).

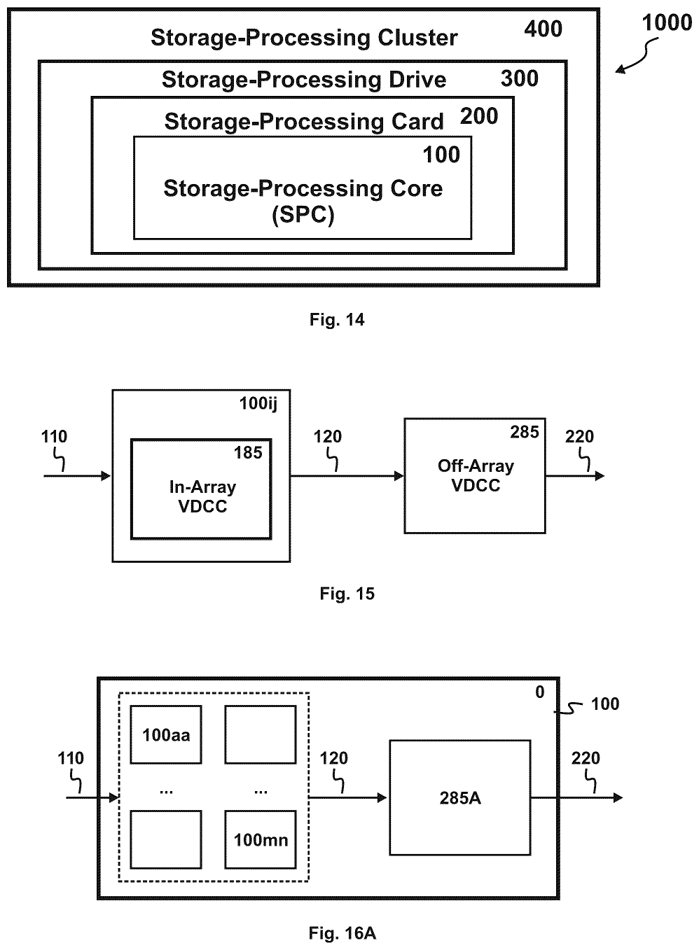

Referring now to FIGS. 14-16D, a preferred storage-processing hierarchy 1000 and the associated hybrid VDCC's are disclosed. As shown in FIG. 14, the SPC's 100 can be packaged into storage-processing cards 200; the storage-processing cards 200 can be packaged into storage-processing drives 300; and, the storage-processing drives 300 can be packaged into storage-processing clusters 400. They form a storage-processing hierarchy 1000. Each level of the storage-processing hierarchy has its own vector-computing circuit, e.g., VDCC, filtering circuit, and sorting circuit. The computing circuit at a lower level is generally less complex than the one at a higher level. Moreover, the selection criterion at a lower level is more lenient. Accordingly, the present invention discloses hybrid VDCC's. As is shown in FIG. 15, the preferred hybrid VDCC's comprises an in-array VDCC 185 and an off-array VDCC 285. The in-array VDCC 185 is disposed in/under the storage arrays, while the off-array VDCC 285 is disposed outside the storage arrays.

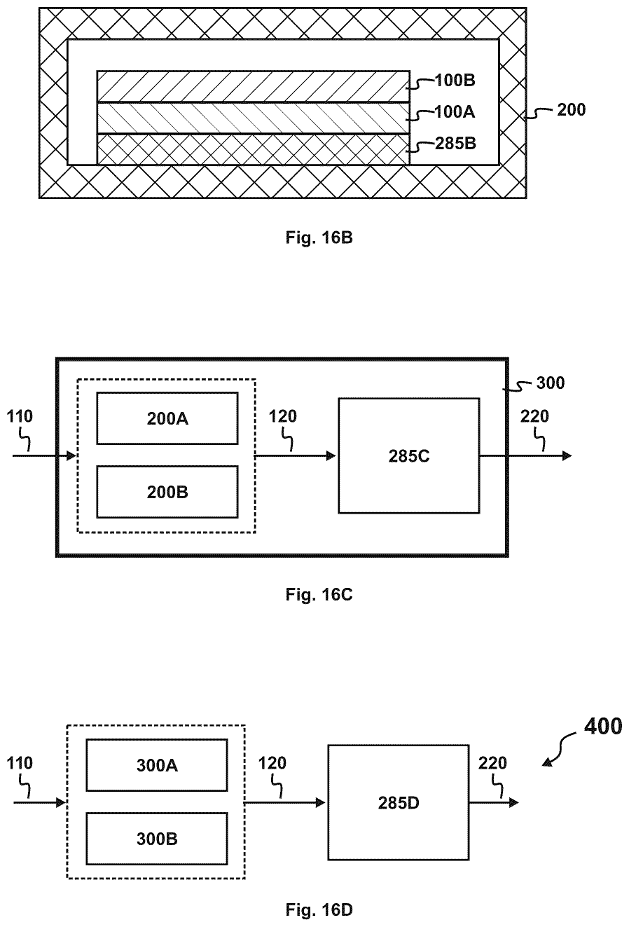

FIGS. 16A-16D give a few examples of the preferred storage-processing bodies. They can all use the hybrid VDCC of FIG. 15. In the embodiment of FIG. 16A, the off-array VDCC 285A is located on the same semiconductor substrate 0 with the in-array VDCC 185, but it is located outside all SPU's 100aa-100mn. It serves all SPU's 100aa-100mn within the same SPC 100. In the embodiment of FIG. 16B, the off-array VDCC 285B are disposed on a different die than the SPC's 100A, 100B. They overlap each other and are packaged into a storage-processing card 200. The off-array VDCC 285B serves the SPC's 100A, 100A. In the embodiment of FIG. 16C, the off-array VDCC 285C and the storage-processing cards 200A, 200B are packaged into a storage-processing drive 300. It serves the storage-processing cards 200A, 200B. In the embodiment of FIG. 16D, the off-array VDCC 285D serves the storage-processing drives 300A, 300B.

In the storage-processing hierarchy 1000 (FIGS. 16A-16D), the computing circuit at a higher level is generally more complex than the one at a lower level. Moreover, the selection criterion at a higher level is more strict. For example, at the SPC level (FIG. 16A), the in-array VDCC 185 uses a simple vector-distance calculating algorithm, e.g., Manhattan distance (uses subtraction, no multiplication); the off-array VDCC 285A uses a complex vector-distance calculating algorithm, e.g., Euclidean distance (uses square and square root). At the storage-processing card level (FIG. 16B), the VDCC 285B uses a more complex vector-distance calculating algorithm, e.g., Standardized Euclidean distance (uses square, division and square root). At the storage-processing drive level (FIG. 16C) and the storage-processing cluster level (FIG. 16D), the VDCC's 285C,285D may use an even more complex vector-distance calculating algorithm, e.g., cosine similarity (uses square, division and square root). Furthermore, the VDCC at selected level(s) can be reconfigurable VDCC. Because data are filtered at various levels, less and less data are sent from a lower level to a higher level. This can significantly lower the bandwidth requirements and improve performance.

One great advantage of the present invention is that its brute-force search time is roughly independent of scale Z of the vector database. Brute-force search includes the following three actions: vector reading, distance calculation, and minimum distance search. Due to parallel execution of vector reading and distance calculation in all SPU's, the total brute-force search time includes: the data-reading time (t_{wa}) of all vectors in an SPU, the vector-distance calculation time (t_{vd}) of all vectors in an SPU, and the search time for the minimum distance among all vector distances in the entire vector database (Tₘₛ). Among them, t_{wa} and t_{vd} are independent of Z, but only proportional to the storage capacity z of an SPU; only Tₘₛ is related to Z, but its relationship Tₘₛ∝log₂(Z) (see FIG. 11) is much weaker than the proportional relationship in prior art. Taking 3D-XPoint as an example, t_{wa}+t_{vd}˜10 ms; for a large-scale vector database, if Z=10¹², then Tₘₛ˜20 us; if Z=10¹⁵, then Tₘₛ˜30 us. Apparently, Tₘₛ<<t_{wa}+t_{vd}. Hence, the brute-force search time of the present invention is roughly independent of Z: no matter whether Z is trillion (10¹²), quadrillion (10¹⁵), or even higher, the search time is about the same (e.g., ˜10 ms). Compared with prior art where search time increases with Z, the consistency of the search time in the present invention can greatly simplify system design. On the other hand, to save energy, the brute-force search does not need to be performed in the entire vector database. It only needs to be performed in a selected portion of the vector database.

Finally, impact of the present invention will be discussed. Modeling plays a key role in AI. In the large-language model (LLM), the computing cost for modeling (C) is proportional to the product of the parameter size (P) and the data size (D) (i.e., C≈6PD). Since P is roughly proportional to D, the computing cost for modeling is proportional to the square of data size (i.e., C∝D²). This leads to a dire consequence for “AI scaling.”

“AI scaling” scales data the LLM handles. It is anticipated that the data size will grow by one thousand times (1,000×). Based on the above square relationship (C∝D²), the modeling cost (including chip cost and energy cost) will increase by one million times (1,000,000×). This sharp increase in demands for chips and energy cannot be supported by resources on earth. Hence, the modeling-based AI is not sustainable.

In fact, modeling/fitting is not the only method for numerical analysis. The two basic tools for numerical analysis are fitting and interpolation. Interpolation estimates the value of an unknown point from its neighbors. It can achieve the same result as fitting. Fitting has less requirement on storage (provided that its parameters size is much smaller than the data size), but requires a separate modeling (parameter extraction) step and therefore, a large computational power; interpolation does not require a separate modeling step and therefore has little requirement on the computational power, but requires a large storage space and associated search capability.

In the past, modeling/fitting is the main stream. As the computational power is relatively abundant, modeling is the preferred method for AI. When the computational power is no longer adequate due to AI scaling, interpolation starts to gain tractions. Vector database and retrieval-augmented generation (RAG) are typical examples of interpolation. The top-k nearest-neighbor search is the exact method used by interpolation. However, the prior-art vector database, although making improvements on the software side, is still built on the conventional hardware. This limits its accuracy, speed, dimensions, and scale. As a result, the prior-art vector database is limited to small-scale knowledge bases. The present invention, empowering accurate and fast search for large-scale and high-dimensional vector database, broadens the applications of vector database to general human knowledge (world knowledge base). More importantly, its cost (storage cost and computing cost) are proportional to data size (C∝D¹). Compared with prior art where computing cost is proportional to the square of the data size (C∝D²), the present invention is much more sustainable. Hence, “computational power” is not the only approach to world knowledge base, “storage power” (not just storage, but storage with accurate and fast searching capability) is also a viable approach

The present invention can also be applied to scientific computing and engineering instrumentation. For example, in metrology, it is often necessary to compare the measured vector with a library of pre-computed vectors to find the nearest pre-computed vector and use that to determine the initial guess for the parameters to be measured. This brute-force search can directly find the global minimum, thereby avoiding being stuck in a local minimum and reducing the computational power required for regression calculations.

While illustrative embodiments have been shown and described, it would be apparent to those skilled in the art that many more modifications than that have been mentioned above are possible without departing from the inventive concepts set forth therein. The invention, therefore, is not to be limited except in the spirit of the appended claims.

1. A vector database, comprising an input for inputting a query vector and at least a storage-processing core (SPC) coupled with said input, wherein said SPC comprises:
a plurality of storage-processing units (SPU's), each of said plurality of SPU's comprising at least a storage array for storing at least a data vector in said vector database, and a vector-distance calculation circuit (VDCC) for calculating a distance between said query vector and said data vector;
at least a semiconductor substrate, wherein said VDCC is disposed on said semiconductor substrate; said storage array is disposed above said VDCC; said VDCC and the projection of said storage array on said semiconductor substrate at least partially overlap; said VDCC and said storage array are communicatively coupled.

2. The vector database according to claim 1, further comprising a minimum-distance search circuit (MDSC) for searching at least a minimum distance from the distances calculated by the VDCC's in said plurality of SPU's.

3. The vector database according to claim 1, wherein said SPC is a single die comprising said semiconductor substrate.

4. The vector database according to claim 1, wherein:
said SPC is a doublet comprising bonded first and second dice, wherein said first die comprises said semiconductor substrate, and said second die comprises another semiconductor substrate;
the VDCC's of said plurality of SPU's are disposed on said first die;
the storage arrays of said plurality of SPU's are disposed on said second die.

5. The vector database according to claim 4, wherein said first and second dice are face-to-face bonded.

6. The vector database according to claim 1, wherein said SPU is a reconfigurable SPU.

7. The vector database according to claim 1, wherein said VDCC is a reconfigurable VDCC for performing a weighted sum.

8. The vector database according to claim 2, wherein said MDSC is a binary-tree comparison circuit.

9. The vector database according to claim 2, further comprising:
a plurality of distance registers for storing the distance calculated by the VDCC's in said plurality of SPU's;
a reset circuit for resetting the distance register associated with said minimum distance to a pre-determined value after said minimum distance is found.

10. The vector database according to claim 1, further comprising an off-array VDCC, wherein said VDCC uses a different vector-distance calculating algorithm than said off-array VDCC.

11. A vector database, comprising an input for inputting a query vector and at least a storage-processing core (SPC) coupled with said input, wherein said SPC comprises:
a plurality of storage-processing units (SPU's), each of said plurality of SPU's comprising at least a storage array for storing at least a data vector in said vector database, and a vector-distance calculation circuit (VDCC) for calculating a distance between said query vector and said data vector; and,
a minimum-distance search circuit (MDSC) for searching at least a minimum distance from the distances calculated by the VDCC's in said plurality of SPU's.

12. The vector database according to claim 11, further comprising: at least a semiconductor substrate, wherein said VDCC is disposed on said semiconductor substrate; said storage array is disposed above said VDCC; said VDCC and the projection of said storage array on said semiconductor substrate at least partially overlap; said VDCC and said storage array are communicatively coupled.

13. The vector database according to claim 12, wherein said SPC is a single die comprising said semiconductor substrate.

14. The vector database according to claim 12, wherein:
said SPC is a doublet comprising bonded first and second dice, wherein said first die comprises said semiconductor substrate, and said second die comprises another semiconductor substrate;
the VDCC's of said plurality of SPU's are disposed on said first die;
the storage arrays of said plurality of SPU's are disposed on said second die.

15. The vector database according to claim 14, wherein said first and second dice are face-to-face bonded.

16. The vector database according to claim 11, wherein said SPU is a reconfigurable SPU.

17. The vector database according to claim 11, wherein said VDCC is a reconfigurable VDCC for performing a weighted sum.

18. The vector database according to claim 11, wherein said MDSC is a binary-tree comparison circuit.

19. The vector database according to claim 11, further comprising:
a plurality of distance registers for storing the distance calculated by the VDCC's in said plurality of SPU's;
a reset circuit for resetting the distance register associated with said minimum distance to a pre-determined value after said minimum distance is found.

20. The vector database according to claim 11, further comprising an off-array VDCC, wherein said VDCC uses a different vector-distance calculating algorithm than said off-array VDCC.
